(19) United States
(12) Patent Application Publication
(10) Pub. No.: US 2008/0229548 A1
(43) Pub. Date: Sep. 25, 2008

(54) Weatherproof vertical door jamb

(76) Inventors: Thomas Terrance Kimener, Loveland, OH (US); Michael Voeller, Port Washington, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 12/077,682

(22) Filed: Mar. 20, 2008

Related U.S. Application Data
(60) Provisional application No. 60/919,027, filed on Mar. 20, 2007.

(51) Int. Cl. E05D 15/16; B21C 23/00

(52) U.S. Cl. 16/96 R; 72/253.1

(57) ABSTRACT

A door jamb for a break-away industrial door including at least one weather strip and methods for making the same. The door jamb may include a guide track which supports one or more pieces of weather stripping. The guide track may be constructed to allow the break-away door to leave the track if the door is deformed to a predetermined extent. The guide track may be formed by an extrusion process.

### CROSS REFERENCE TO RELATED APPLICATION

This application claims the benefit of U.S. Provisional Application No. 60/919,027, filed Mar. 20, 2007, which is hereby incorporated by reference in its entirety.

### BACKGROUND OF THE INVENTION

1. Field of the Invention

The instant invention is directed to weatherproofing roll-up industrial doors that are adapted to break away from the vertical track of a wall jamb, as well as to vertical wall jambs having tracks that guide roll-up industrial doors. The invention also includes associated methods of fabricating weatherproof vertical wall jambs.

2. Description of the Related Art

Conventional roll-up doors often include vertical guide tracks mounted to the sides of the door opening. Break-away doors are designed to deform and disengage from the guide tracks when a predetermined force is applied to the door.

### INTRODUCTION TO THE INVENTION

Embodiments of the invention provide a door jamb for a break-away industrial door including at least one weather strip and methods for making the same. The door jamb may include a guide track which supports one or more pieces of weather stripping. The guide track may be constructed to allow the break-away door to leave the track if the door is deformed to a predetermined extent. The guide track may be formed by an extrusion process.

In a first aspect, a vertical track for an industrial door according to the present invention may include a longitudinal guide track including a first longitudinal wall and a second longitudinal wall, both extending from a first side of a platform, the first longitudinal wall and the second longitudinal wall substantially in parallel to and spaced apart from one another, the first longitudinal wall including a first longitudinal groove facing the second longitudinal wall, and at least two longitudinal legs extending from a second side of the platform, the second side of the platform being opposite the first side of the platform; and a first weather strip operatively coupled to the groove such that the weather strip extends towards the second longitudinal wall.

In a detailed embodiment of the first aspect, the at least two longitudinal legs may be oriented substantially perpendicular to the second side of the platform.

In another detailed embodiment of the first aspect, at least one of the first and second longitudinal walls may include two side walls and an upper wall; the two side walls, the upper wall, and at least a portion of the platform substantially defining a longitudinal cavity. At least one of the two side walls and the upper wall may have a convex shape.

In yet another detailed embodiment of the first aspect, The track may further include a second weather strip, the second longitudinal wall may include a second longitudinal groove facing the first longitudinal wall, and the second weather strip may be operatively coupled to the second groove such that the second weather strip extends towards the first longitudinal wall.

In yet another detailed embodiment of the first aspect, the first longitudinal wall and the second longitudinal wall may be oriented substantially perpendicular to the first side of the platform.

In a second aspect, a method of fabricating a vertical guide track for an industrial door according to the present invention may include the steps of extruding a guide track including a platform with a first integral longitudinal arm and a second integral longitudinal arm, the first integral longitudinal arm including a first groove facing the second longitudinal arm.

In a detailed embodiment of the second aspect, the first and second integral longitudinal arms may extend from a first side of the platform and two integral spaced-apart legs may extend from a second side of the platform, the second side of the platform being opposite the first side of the platform. The two space-apart legs may be oriented substantially perpendicular to the second side of the platform.

In another detailed embodiment of the second aspect, the method may further include the step of installing a first weather strip onto the guide track by operatively coupling the first weather strip with the first groove so that the first weather strip extends towards the second integral longitudinal arm. The second integral longitudinal arm may include a second groove and the method may further include the step of installing a second weather strip onto the guide track by operatively coupling the second weather strip with the second groove.

In yet another detailed embodiment of the second aspect, the first integral longitudinal arm and the second integral longitudinal arm may be oriented substantially perpendicular to the platform.

In yet another detailed embodiment of the second aspect, at least one of the first integral longitudinal arm and the second integral longitudinal arm may include a plurality of walls substantially defining a longitudinal cavity. At least one of the plurality of walls may be convex.

In a third aspect, a member for a door jamb according to the present invention may include a longitudinal base with a generally rectangular cross section having a first side and a second side; a longitudinal arm extending generally perpendicularly from the first side of the longitudinal base, the longitudinal arm having a first side and a second side, the first side of the longitudinal arm including a longitudinal groove, the longitudinal groove having a substantially uniform cross section; and a longitudinal leg extending generally perpendicularly from the second side of the longitudinal base. The first side of the longitudinal arm may be oriented generally towards a first end of the longitudinal base and the longitudinal leg may extend from the longitudinal base proximate a second end of the longitudinal base, the second end being opposite from the first end.

In a detailed embodiment of the third aspect, the longitudinal base may include at least one orifice adapted to receive a fastener, the at least one orifice extending through the longitudinal base at a location between the longitudinal arm and the first end of the longitudinal base.

In another detailed embodiment of the third aspect, the longitudinal arm may include a longitudinal cavity substantially defined by a plurality of walls. The plurality of walls may include two side walls and an end wall. At least one of the two side walls and the end wall may be convex.

In a fourth aspect, a weatherproof industrial door jamb according to the present invention may include a longitudinal platform having a surface and a first end and a second end, the first end being opposite the second end; a first longitudinal arm extending generally perpendicularly from the surface proximate the first end of the longitudinal platform, the first longitudinal arm including a first longitudinal groove having a substantially uniform cross section facing the second end of the longitudinal platform; and a second longitudinal arm extending generally perpendicularly from the surface proximate the second end of the platform, the second longitudinal arm including a second longitudinal groove having a substantially uniform cross section facing the first end of the longitudinal platform. At least one of the first longitudinal arm and the second longitudinal arm may include a longitudinal cavity defined by two side walls and an end wall.

### BRIEF DESCRIPTION OF THE SEVERAL VIEWS OF THE DRAWINGS

FIG. 1 is a cross-section of a first exemplary door jamb for an industrial door;

FIG. 2 is a cross-section of a first exemplary weatherproof door jamb using the door jamb of FIG. 1;

FIG. 3 is a cross-section of the first exemplary weatherproof door jamb of FIG. 2 accommodating an industrial door;

FIG. 4 is a cross-section of a second exemplary door jamb for an industrial door;

FIG. 5 is a cross-section of a second exemplary weatherproof door jamb using the door jamb of FIG. 4;

FIG. 6 is a cross-section of the second exemplary weatherproof door jamb of FIG. 5 accommodating an industrial door;

FIGS. 7A-C are a series of cross sectional views of alternate exemplary grooves adapted to accommodate weatherstripping in accordance with the present invention; and

FIG. 8 is a cross sectional view of an exemplary two-piece weatherproof door jamb.

### DETAILED DESCRIPTION OF THE INVENTION

The exemplary embodiments of the present invention are described and illustrated below to encompass methods of fabricating weatherproof door jambs for industrial overhead doors, as well as the associated weatherproof door jambs themselves. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention as defined by the proposed points of novelty.

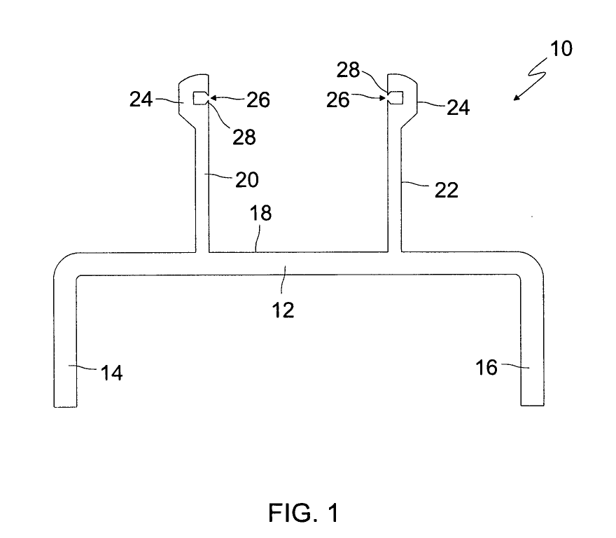

Referring to FIG. 1, a first exemplary door jamb 10 comprises a longitudinal rail 12 having opposing left and right legs 14, 16 connected to one another by a horizontal platform 18. In this exemplary embodiment, the legs 14, 16 are oriented perpendicularly with respect to the platform 18. A pair of longitudinal guide arms 20, 22 upstand from a surface of the platform 18 opposite the left and right legs 14, 16. Each guide arm 20, 22 is generally perpendicular to the platform 18 and includes a longitudinal head 24 opposite the platform 18.

The head 24 includes a longitudinal groove 26 formed therein having a generally rectangular cross-section that tapers to an hourglass shape partially defined by opposing teeth 28 projecting inward toward one another from the head 24. In this exemplary embodiment, the groove 26 is adapted to receive a longitudinal section of weatherstripping 30. As used herein, weatherstripping refers to one or more weather strips.

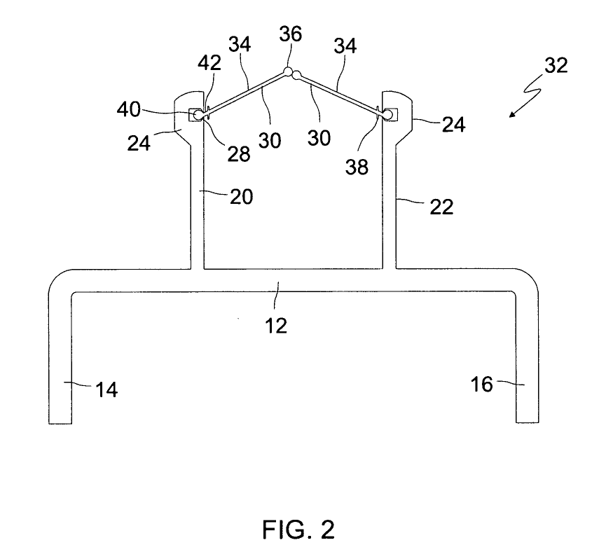

Referring to FIG. 2, the weatherstripping 30 comprises an integral longitudinal length that is fabricated using extrusion, such as pull extrusion. An exemplary cross-section of the weatherstripping 30 reveals numerous portions that cooperate with the door jamb 10 to form a weatherproof door jamb 32. For example, the weatherstripping 30 includes a flange 34, having a rounded end 36, that extends from a stop 38 that is adapted to abut the teeth 28 of the head 24 when the weatherstripping 30 is installed within the groove 26. A rectangular-shaped projection 40 of the weatherstripping is connected to the stop 38 by way of a bridge 42 and is received within the groove 26 to retain the weatherstripping 30 in engagement with the door jamb 10.

In this exemplary embodiment, the door jamb 10 is fabricated from a mixture of a thermoplastic polymer and fiberglass injected into a die and pull extruded. It is also within the scope of the invention to utilize a thermosetting polymer or other materials to form the door jamb using a molding or extrusion process. Those skilled in the art will be familiar with the advantages imparted by using an extrusion process such as, without limitation, varying the lengths of the door jambs 10 to accommodate varying length walls, without having to fabricate differing molds.

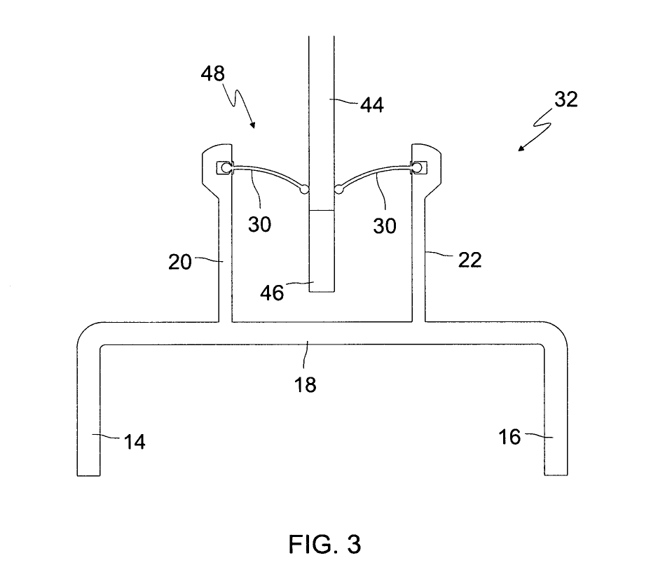

Referencing FIG. 3, the weatherproof door jamb 32 is adapted for use with break-away industrial doors 44 such as those fabricated from flexible frames and covered with a plastic curtain. These exemplary break-away doors 44 are often stored in a rolled up position by using an overhead roller (not shown) that is driven by a motor (not shown). While it is not critical for purposes of the instant invention which type of break-away door 44 is utilized, it is important to understand the operation of typical break-away industrial doors.

An exemplary industrial break-away door 44 includes a frame 46 that is flexible enough to deform when a force is applied to the door. Generally the applied force comes from a collision with an automobile or other object, but need not, as in the case of a strong wind causing the door 44 to break-away. Initially, just before a force is applied to the door, the ends of the frame 46 are within the track 48. As an initial force is applied to the door, the frame 46 bows outward in the direction of the force being applied. This outward bowing pulls the ends of the frame toward one another, thereby decreasing the widthwise dimension of the door. At a predetermined point, the widthwise dimension of the door (and or door panel) becomes less then the width between opposing door jamb tracks, which allows the door to become dislodged from between the guide arms 20, 22 comprising the track. To account for the bowed movement of the door frame, many tracks are particularly wide to ensure that while the door its is being bowed out it does not become bound up within the track. However, this increase in the width of the track for the sake of allowing the door to flex has come at the expense of sacrificing weatherproofing.

Referring again to FIG. 3, the weatherproof door jamb 32 accommodates for an increased width track, while at the same time ensuring that gaps between the door 44 and guide arms 20, 22 are reduced by using weatherstripping 30, particularly during flexing of the door. As shown in FIG. 3, the weatherstripping 30 deforms to accommodate insertion of the door 44 (particularly the frame 46) and forms a compliant seal to inhibit substantial travel of gases, liquids, and mists from passing between the door 44 and weatherstripping 30 when the door is positioned within the tracks. Yet the flexibility of the weatherstripping allows the door substantial movement within the track 46, while maintaining the compliant seal until reaching a point when the door is dislodged from the track.

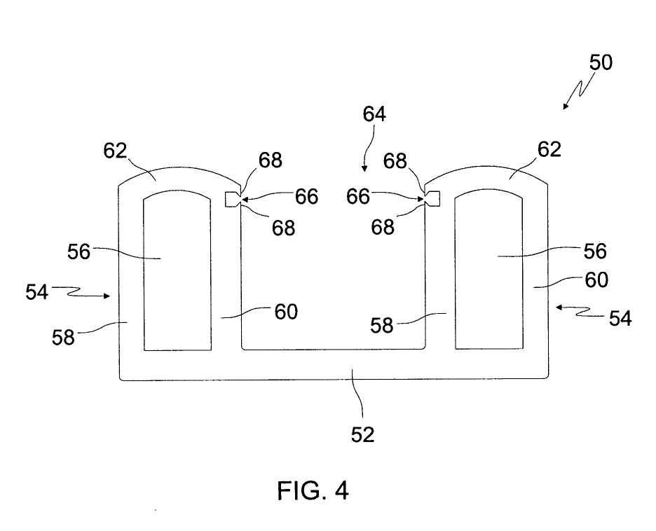

Referencing FIG. 4, a second exemplary door jamb 50 comprises a horizontal platform 52 having a pair of bubbled projections 54. Each bubbled projection 54 includes a longitudinal cavity 56 bounded by substantially vertical right and left side walls 58, 60, a substantially horizontal bottom wall comprising the platform 52, and a convex upper wall 62. The left side wall 58 of one projection 54 faces the right side wall 60 of the other projection 54 to define a track 64 therebetween. Each interior wall 58, 60 includes a longitudinal groove 66 approximate the inception of the convex upper wall 62. This longitudinal groove 66 includes a generally rectangular cross-section that tapers to an hourglass shape partially defined by opposing teeth 68 projecting inward toward one another. In this exemplary embodiment, the groove 66 is adapted to receive a longitudinal section of weatherstripping 70.

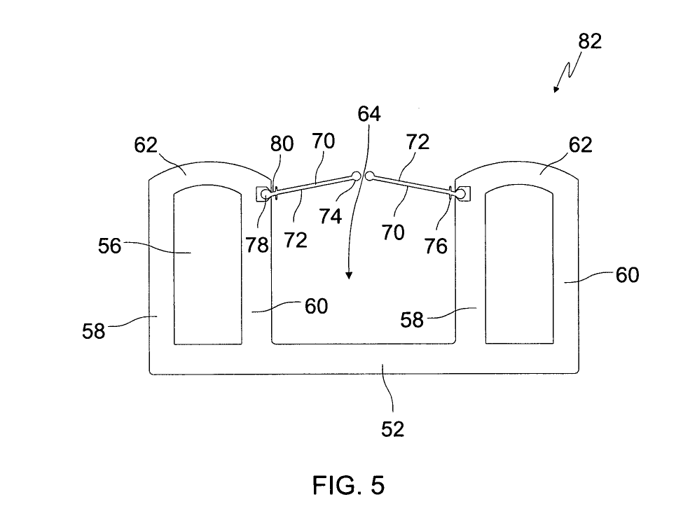

Referring to FIG. 5, the weatherstripping 70 is extruded to create a longitudinal profile having one end adapted to be received within the groove 66. This profile includes a flange 72, having a rounded end 74, that extends from a stop 76 that is adapted to abut the teeth 68 when the weatherstripping 70 is installed within the groove 66. A rectangular-shaped projection 78 of the weatherstripping is connected to the stop 76 by way of a bridge 80 positioned to interpose the teeth 68. Coupling of the weatherstripping 70 to the door jamb 50 creates a weatherproof industrial door jamb 82

In this exemplary embodiment, the door jamb 50 is fabricated from a mixture of a thermoplastic polymer and fiberglass injected into a die and pull extruded. It is also within the scope of the invention to utilize a thermosetting polymer or other materials to form the door jamb using a molding or extrusion process. Those skilled in the art will be familiar with the advantages imparted by using an extrusion process such as, without limitation, varying the lengths of the door jambs 50 to accommodate varying length walls, without having to fabricate differing molds.

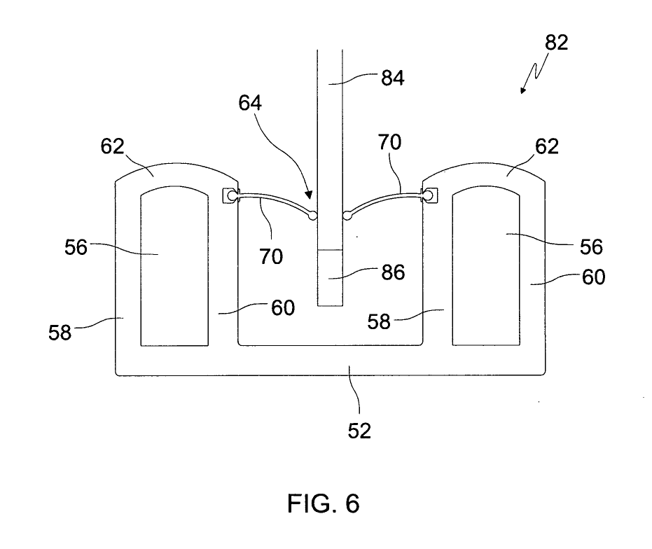

Referencing FIG. 6, the weatherproof door jamb 82 is adapted for use with break-away industrial doors 84 such as those fabricated from flexible frames 86 and covered with a plastic curtain. These exemplary break-away doors 84 are often stored in a rolled up position by using an overhead roller (not shown) that is driven by a motor (not shown). While it is not critical for purposes of the instant invention which type of break-away door 84 is utilized, it is important to understand the operation of typical break-away doors.

Referring again to FIG. 6, the weatherproof door jamb 82 accommodates an increased width track, while at the same time ensuring that gaps between the door 84 and interior walls 58, 60 are reduced by using weatherstripping 70, particularly during flexing of the door. As shown in FIG. 6, the weatherstripping 70 deforms to accommodate insertion of the door 84 (particularly the frame 86) and forms a compliant seal to inhibit substantial travel of gases, liquids, and mists from passing between the door 84 and weatherstripping 70 when the door is positioned within the tracks. Yet the flexibility of the weatherstripping allows the door substantial movement within the track 64, while maintaining the compliant seal until reaching a point when the door is no longer within the track.

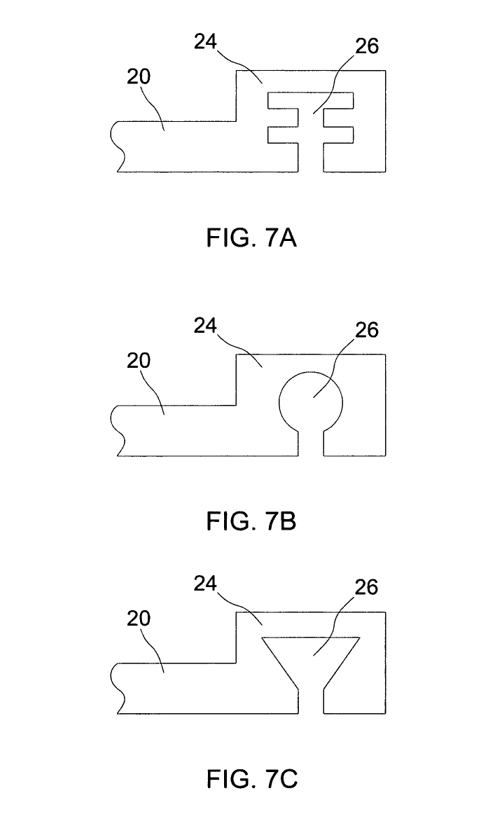

Referencing FIGS. 7A-C, a plurality of alternate groove shapes may be used in lieu of the foregoing exemplary longitudinal groove 66 having a generally rectangular cross-section that tapers to an hourglass shape partially defined by opposing teeth 68 projecting inward toward one another. Those skilled in the art will understand from the foregoing explanation that various shaped grooves may be utilized with the underlying premise of retaining the weather stripping in a weatherproofing position with respect to the industrial door jamb. FIG. 7A depicts an H-shaped groove, FIG. 7B depicts a circular groove, and FIG. 7C depicts a triangular shaped groove. In addition, the groove may simply comprise an indentation of any shape (for example and without limitation, a rectangular groove) in the head, with or without teeth. Certain embodiments may utilize one or more retention devices (such as, but not limited to, one or more fasteners and/or retention strips) and/or an adhesive to retain the weather stripping within the groove.

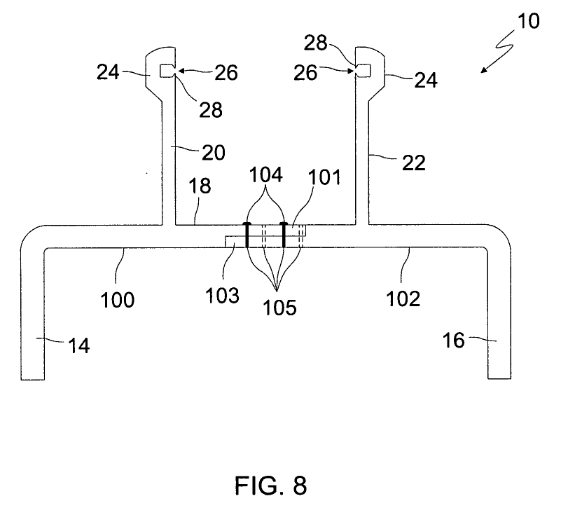

Referring to FIG. 8, it is also within the scope of the invention to fabricate the industrial door jamb in multiple pieces, such as fabricating the door jamb in halves, where each half 100, 102 includes a generally stair stepped cross-section with a joining projection 101, 103 on each half 100, 102. This alternate exemplary embodiment is operative to accommodate jambs of various widths. In exemplary form, each half is fabricated so that the joining projections can mount to one another to comprise the jamb. In exemplary form, each joining projection is machined to include horizontal openings 105 at predetermined height intervals that are adapted to receive associated fasteners 104 to lock the overall widthwise dimension of the door jamb.

Following from the above description and invention summaries, it should be apparent to those of ordinary skill in the art that, while the methods and apparatus herein described constitute an exemplary embodiment of the present invention, the invention contained herein is not limited to this precise embodiment and that changes may be made to this embodiment without departing from the scope of the invention as defined by the claims. Likewise, it is to be understood that it is not necessary to meet any or all of the identified advantages or objects of the invention disclosed herein in order to fall within the scope of the invention, since the invention is defined by the claims and since inherent and/or unforeseen advantages of the present invention may exist even though they may not have been explicitly discussed herein. Finally, it will be apparent that additional claims may be inherent in the invention and not expressly described herein.

What is claimed is:

1. A vertical track for an industrial door comprising:
a longitudinal guide track including
a first longitudinal wall and a second longitudinal wall, both extending from a first side of a platform, the first longitudinal wall and the second longitudinal wall substantially in parallel to and spaced apart from one another, the first longitudinal wall including a first longitudinal groove facing the second longitudinal wall, and
at least two longitudinal legs extending from a second side of the platform, the second side of the platform being opposite the first side of the platform; and
a first weather strip operatively coupled to the groove such that the weather strip extends towards the second longitudinal wall.

2. The track of claim 1, wherein the at least two longitudinal legs are oriented substantially perpendicular to the second side of the platform.

3. The track of claim 1, wherein at least one of the first and second longitudinal walls includes two side walls and an upper wall; the two side walls, the upper wall, and at least a portion of the platform substantially defining a longitudinal cavity.

4. The track of claim 3, wherein at least one of the two side walls and the upper wall has a convex shape.

5. The track of claim 1, further comprising a second weather strip;
wherein the second longitudinal wall includes a second longitudinal groove facing the first longitudinal wall; and
wherein the second weather strip is operatively coupled to the second groove such that the second weather strip extends towards the first longitudinal wall.

6. The track of claim 1, wherein the first longitudinal wall and the second longitudinal wall are oriented substantially perpendicular to the first side of the platform.

7. A method of fabricating a vertical guide track for an industrial door comprising the steps of:
extruding a guide track including a platform with a first integral longitudinal arm and a second integral longitudinal arm, the first integral longitudinal arm including a first groove facing the second longitudinal arm.

8. The method of claim 7, wherein the first and second integral longitudinal arms extend from a first side of the platform and two integral spaced-apart legs extend from a second side of the platform, the second side of the platform being opposite the first side of the platform.

9. The method of claim 8, wherein the two space-apart legs are oriented substantially perpendicular to the second side of the platform.

10. The method of claim 7, further comprising the step of installing a first weather strip onto the guide track by operatively coupling the first weather strip with the first groove so that the first weather strip extends towards the second integral longitudinal arm.

11. The method of claim 10, wherein the second integral longitudinal arm includes a second groove; and wherein the method further comprises the step of installing a second weather strip onto the guide track by operatively coupling the second weather strip with the second groove.

12. The method of claim 7, wherein the first integral longitudinal arm and the second integral longitudinal arm are oriented substantially perpendicular to the platform.

13. The method of claim 7, wherein at least one of the first integral longitudinal arm and the second integral longitudinal arm includes a plurality of walls substantially defining a longitudinal cavity.

14. The method of claim 13, wherein at least one of the plurality of walls is convex.

15. A member for a door jamb comprising:
a longitudinal base with a generally rectangular cross section having a first side and a second side;
a longitudinal arm extending generally perpendicularly from the first side of the longitudinal base, the longitudinal arm having a first side and a second side, the first side of the longitudinal arm including a longitudinal groove, the longitudinal groove having a substantially uniform cross section; and
a longitudinal leg extending generally perpendicularly from the second side of the longitudinal base;
wherein the first side of the longitudinal arm is oriented generally towards a first end of the longitudinal base and the longitudinal leg extends from the longitudinal base proximate a second end of the longitudinal base, the second end being opposite from the first end.

16. The member of claim 15, wherein the longitudinal base includes at least one orifice adapted to receive a fastener, the at least one orifice extending through the longitudinal base at a location between the longitudinal arm and the first end of the longitudinal base.

17. The assembly of claim 15, wherein the longitudinal arm includes a longitudinal cavity substantially defined by a plurality of walls.

18. The member of claim 17, wherein the plurality of walls includes two side walls and an end wall.

19. The assembly of claim 18, wherein at least one of the two side walls and the end wall is convex.

20. A weatherproof industrial door jamb comprising:
a longitudinal platform having a surface and a first end and a second end, the first end being opposite the second end;
a first longitudinal arm extending generally perpendicularly from the surface proximate the first end of the longitudinal platform, the first longitudinal arm including a first longitudinal groove having a substantially uniform cross section facing the second end of the longitudinal platform; and
a second longitudinal arm extending generally perpendicularly from the surface proximate the second end of the platform, the second longitudinal arm including a second longitudinal groove having a substantially uniform cross section facing the first end of the longitudinal platform;
wherein at least one of the first longitudinal arm and the second longitudinal arm includes a longitudinal cavity defined by two side walls and an end wall.
